(19) United States
(12) Patent Application Publication
(10) Pub. No.: US 2021/0209452 A1
(43) Pub. Date: Jul. 8, 2021

(54) LEARNING DEVICE, LEARNING METHOD, AND COMPUTER PROGRAM PRODUCT

(71) Applicant: KABUSHIKI KAISHA TOSHIBA, Tokyo (JP)

(72) Inventor: Reiko NODA, Kawasaki (JP)

(73) Assignee: KABUSHIKI KAISHA TOSHIBA, Tokyo (JP)

(21) Appl. No.: 17/014,721

(22) Filed: Sep. 8, 2020

(30) Foreign Application Priority Data
Jan. 6, 2020 (JP) 2020-000148

(51) Int. Cl. G06N 3/063; G06N 3/04; G06N 3/08; G06N 20/20; G06K 9/62

(52) U.S. Cl. CPC G06N 3/063; G06N 3/0454; G06K 9/6256; G06N 20/20; G06N 3/08

(57) ABSTRACT

According to an embodiment, a learning device includes a hardware processor. The hardware processor is configured to: perform an inference task by using a first neural network; translate second domain data into first translated data by using a second neural network; update parameters of the second neural network so that a distribution that represents a feature of the first translated data approaches a distribution that represents a feature of the first domain data; and update parameters of the first neural network on a basis of a second inference result output when the first translated data is input into the first neural network, a ground truth label of the first translated data, the first inference result, and a ground truth label of the first domain data.

### CROSS-REFERENCE TO RELATED APPLICATIONS

This application is based upon and claims the benefit of priority from Japanese Patent Application No. 2020-000148, filed on Jan. 6, 2020; the entire contents of which are incorporated herein by reference.

### FIELD

Embodiments described herein relate generally to a learning device, a learning method, and a computer program product.

### BACKGROUND

Techniques of generating learning data used for machine learning, such as a neural network that performs estimation, such as class classification, object detection, position regression, and the like, have been known. For example, a technique of generating data similar to learning data by using deep learning, such as a variational autoencoder (VAE), an adversarial network (GAN), or the like, is used to increase learning data or is substituted for learning data.

However, it has been difficult for conventional techniques to generate learning data that is appropriate for improvement in generalization performance of a neural network used for estimation.

### BRIEF DESCRIPTION OF THE DRAWINGS

FIG. 1 is a drawing that illustrates an example of a function configuration of a learning device according to a first embodiment;

FIG. 2 is a diagram that illustrates a configuration example of neural networks according to the first embodiment;

FIG. 3 is a flowchart that illustrates an example of a learning method according to the first embodiment;

FIG. 4 is a diagram that illustrates a configuration example of neural networks according to a second embodiment;

FIG. 5 is a flowchart that illustrates an example of a learning method according to the second embodiment;

FIG. 6 is a diagram that illustrates a configuration example of neural networks according to a variation of the second embodiment;

FIG. 7 is a diagram that illustrates a configuration example of neural networks according to a third embodiment;

FIG. 8 is a flowchart that illustrates an example of a learning method according to the third embodiment;

FIG. 9 is a diagram that illustrates a configuration example of neural networks according to a fourth embodiment; and

FIG. 10 is a flowchart that illustrates an example of a learning method according to the fourth embodiment.

### DETAILED DESCRIPTION

According to an embodiment, the learning device includes a hardware processor. The hardware processor is configured to: perform an inference task by using a first neural network, the first neural network being configured to receive first domain data and output a first inference result; translate second domain data into first translated data similar to the first domain data by using a second neural network, the second neural network being configured to receive the second domain data and translate the second domain data into the first translated data; update parameters of the second neural network so that a distribution that represents a feature of the first translated data approaches a distribution that represents a feature of the first domain data; and update parameters of the first neural network on a basis of a second inference result output when the first translated data is input into the first neural network, a ground truth label of the first translated data, the first inference result, and a ground truth label of the first domain data.

Hereinafter, embodiments of learning devices, learning methods, and programs will be described in detail with reference to the accompanying drawings.

### First Embodiment

A learning device according to a first embodiment is a device that learns a first neural network. The first neural network receives input of first domain data, such as images, and performs an inference task. The inference task includes, for example, a process of identifying what kind of object a subject in an image is, a process of estimating a position, in an image, of an object in the image, a process of estimating a label of each pixel in an image, a process of regression of positions of features of an object, and the like.

Note that an inference task performed by the first neural network is not limited to the above example, but may include any task that can be inferred by a neural network.

Input into the first neural network, that is to say the first domain data, is not limited to images. The first domain data may include any data that can be input into the first neural network and can be calculated by the first neural network. The first domain data may include, for example, sounds, texts, or moving images, or a combination of any of sounds, texts, and moving images.

A case will be described as an example. In the case, input into the first neural network includes images in front of a vehicle that are captured by a camera attached to the vehicle, and the learning device gives a learning in an inference task that estimates orientations of other vehicles in the images.

To learn such an inference task, the learning device according to the first embodiment stores images (first domain data) preliminarily captured by the camera attached to the vehicle, and ground truth label data. For example, the ground truth label represents a rectangle circumscribed around a vehicle in an image, and represents positions, in the image, of some vertexes of a cuboid circumscribed around the vehicle.

Further, the learning device according to the first embodiment further learns a second neural network to improve generalization performance due to the learning of the first neural network using the first domain data. The second neural network translates second domain data into data similar to the first domain data (data like the first domain data).

The second domain data includes, for example, computer graphics (CGs). A plurality of CG images for learning are automatically generated. Further, a ground truth label of a CG image for learning is not taught by humans but is automatically generated. The ground truth label of a CG image for learning, for example, represents a rectangle circumscribed around a vehicle in the image, and represents positions, in the image, of some vertexes of a cuboid circumscribed around the vehicle.

CG images for learning (second domain data) generated as described above, and a ground truth label that correspond to the CG images for learning are stored in the learning device according to the first embodiment.

Note that the second domain data is not limited to CGs. The second domain data and the ground truth label of the second domain data may be any combination of data and ground truth data that can be used to increase the first domain data or can be substituted for the first domain data. The second domain data may include, for example, image data, or text data defined using words.

Some data contained in the ground truth label of the first domain data may not be contained in the ground truth label of the second domain data. Alternatively, some data contained in the ground truth label of the second domain data may not be contained in the ground truth label of the first domain data.

Further, if the second neural network generates, from a ground truth label of first domain data, data that corresponds to the first domain data, the second neural network may not prepare a ground truth label of second domain data (the ground truth label of the second domain data may be the same as the ground truth label of the first domain data).

The second neural network may be any neural network that can translate second domain data into data similar to first domain data. On the basis of a format of second domain data and a format of first domain data, the most appropriate translation technique may be applied to the second neural network. A translation technique applied to the second neural network is, for example, CycleGAN (Jun-Yan Zhu, Taesung Park, Phillip Isola, Alexei A. Efros, “Unpaired Image-to-Image Translation using Cycle-Consistent Adversarial Networks” ICCV 2017), DCGAN (A. Radford, L. Metz, and S. Chintala. Unsupervised representation learning with deep convolutional generative adversarial networks. In ICLR, 2016), Pix2Pix (Phillip Isola, Jun-Yan Zhu, Tinghui Zhou, Alexei A. Efros, University of California, Berkeley, “Image-to-Image Translation with Conditional Adversarial Nets, ” CVPR2017), or the like.

### Configuration Example

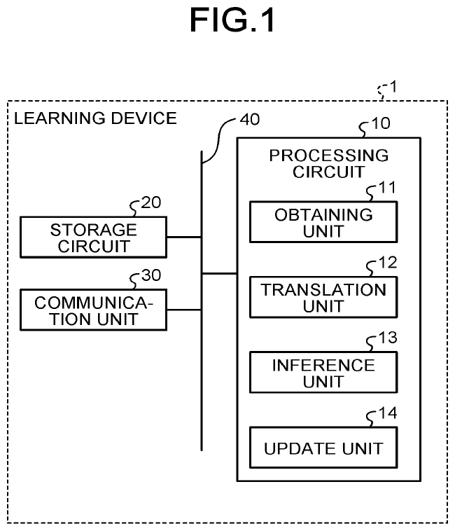

FIG. 1 is a block diagram that illustrates a configuration example of a learning device 1 according to the first embodiment. The learning device 1 includes, for example, a dedicated or general-purpose computer. As illustrated in FIG. 1, the learning device 1 according to the first embodiment includes a processing circuit 10, a storage circuit 20, a communication unit 30, and a bus 40 that connects the processing circuit 10, the storage circuit 20, and the communication unit 30 with each other.

The processing circuit 10 includes an obtaining unit 11, a translation unit 12, an inference unit 13, and an update unit 14. Processes by each of the units will be specifically described below. Note that FIG. 1 illustrates main functional blocks related to the first embodiment, and functions of the processing circuit 10 are not limited to the functional blocks.

Processes of each of the functions performed by the learning device 1 are stored, for example, in the storage circuit 20, in the form of programs performed by the computer. The processing circuit 10 includes a processor that reads programs from the storage circuit 20 and performs the programs, and thus implements a function that corresponds to each of the programs. The processing circuit 10 that has read each of the programs includes each of the functional blocks illustrated in FIG. 1.

Note that although in FIG. 1, the single processing circuit 10 implements each of the functional blocks, a combination of a plurality of separate processors may constitute the processing circuit 10. In this case, each of processing functions may be implemented as a program, or a particular function may be implemented in a dedicated separate circuit that executes programs.

The above “processor” includes, for example, a general-purpose processor, such as a central processing unit (CPU), a graphical processing unit (GPU), or the like, or a circuit, such as an application specific integrated circuit (ASIC), a programmable logic device (for example, a simple programmable logic device (SPLD), a complex programmable logic device (CPLD), a field programmable gate array (FPGA)) or the like.

The processor implements functions by reading and executing programs stored in the storage circuit 20. Note that programs may not be stored in the storage circuit 20, but may be directly built into a circuit of the processor. In this case, the processor implements functions by reading and executing programs built into the circuit.

The storage circuit 20 stores, as necessary, data and the like related to each of the functional blocks of the processing circuit 10. The storage circuit 20 according to the first embodiment stores programs, and data used for various processes. The storage circuit 20 includes, for example, random access memory (RAM), a semiconductor memory device, such as flash memory, a hard disk, an optical disc, or the like. Alternatively, the storage circuit 20 may be substituted with a storage device outside the learning device 1. The storage circuit 20 may include a storage medium that stores or transitorily stores programs downloaded through a local area network (LAN), the Internet, or the like. Further, the number of the storage medium is not limited to one but may be plural.

First domain data, a ground truth label for the first domain data, second domain data, and a ground truth label for the second domain data that are used for learning may be preliminarily stored in the storage circuit. Alternatively, first domain data, a ground truth label for the first domain data, second domain data, and a ground truth label for the second domain data that are used for learning may be preliminarily stored in a device, such as another server. Further, part of the first domain data, the ground truth label for the first domain data, the second domain data, and the ground truth label for the second domain data that are stored in the device, such as another server, may be read through a LAN or the like to be stored in the storage circuit.

The communication unit 30 includes an interface that performs input and output of information between the communication unit 30 and external devices connected with the communication unit 30 through wired or wireless connection. The communication unit 30 may perform communication through a network.

Next, processes of each of the functional blocks of the processing circuit 10 will be described.

The obtaining unit 11 reads first domain data and a ground truth label of the first domain data from the storage circuit 20 as learning data. Further, the obtaining unit 11 reads second domain data and a ground truth label of the second domain data from the storage circuit 20 as learning data.

The translation unit 12 uses a neural network to receive the second domain data, and to translate the second domain data into first translated data similar to the first domain data. Note that details of a configuration of the neural network used for the translation will be described below.

The inference unit 13 inputs the learning data that has been read by the obtaining unit 11 into a neural network that is an object of the learning. Further, the inference unit 13 calculates output from the neural network into which the learning data has been input. Note that details of a configuration of the neural network that is an object of the learning will be described below.

The update unit 14 updates parameters of the neural networks on the basis of the output calculated by the inference unit 13, and the learning data read by the obtaining unit 11 (the ground truth label of the first domain data or the ground truth label of the second domain data). Note that details of the update method will be described below.

### Configuration Example of Neural Networks

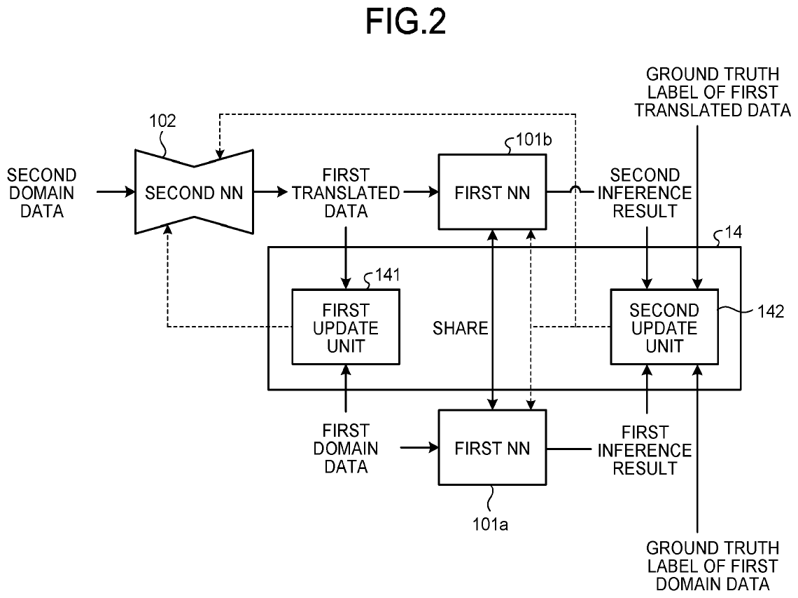

FIG. 2 is a diagram that illustrates a configuration example of neural networks according to the first embodiment. In the example in FIG. 2, actual images are used as first domain data, and CGs are used as second domain data.

The first and second domain data may include RGB color images, or color images with converted color spaces (for example, YUV color images). Alternatively, the first and second domain data may include one-channel images that are obtained by converting color images into monochrome images. Alternatively, the first and second domain data may not include unprocessed images but may include, for example, RGB color images from which a mean value of pixel values of each channel is subtracted. Alternatively, the first and second domain data may include, for example, normalized images. The normalized images may have, for example, pixel values of each pixel that are in a range from zero to one or a range from minus one to one. The normalization includes, for example, subtracting a mean value from a pixel value of each pixel, and then dividing each of the pixel values by a variance or by a dynamic range of the pixel values of an image.

As illustrated in FIG. 2, if a first neural network (hereinafter, a “neural network” is designated by “NN” in the drawings) 101a receives input of the first domain data, the first neural network 101a outputs a first inference result.

If a second neural network 102 receives input of the second domain data, the second neural network 102 translates the second domain data into first translated data similar to the first domain data, and outputs the first translated data.

If a first neural network 101b receives input of the first translated data, the first neural network 101b outputs a second inference result. Note that at least part or all of parameters (weights) of the first neural network 101b are shared with the first neural network 101a (hereinafter, “share” is designated by “share” in the drawings). If all parameters (weights) are shared between the first neural networks 101a and 101b, the first neural networks 101a and 101b are implemented as one first neural network 101.

The first neural networks 101a and 101b are used by the above inference unit 13 that performs inference tasks. The second neural network 102 is used by the above translation unit 12.

Parameters of the first neural networks 101a and 101b and the second neural network 102 are updated by the update unit 14. The update unit 14 includes a first update unit 141 and a second update unit 142.

The first update unit 141 receives the first domain data from the first neural network 101a. Then the first update unit 141 updates the parameters of the second neural network 102 so that a distribution that represents features of the first translated data becomes similar to a distribution that represents features of the first domain data.

The second update unit 142 receives the second inference result from the first neural network 101b, receives a ground truth label of the first translated data from the obtaining unit 11, receives the first inference result from the first neural network 101a, and receives a ground truth label of the first domain data from the obtaining unit 11.

Then the second update unit 142 updates the parameters of the first neural networks 101a and 101b on the basis of the second inference result, the ground truth label of the first translated data, the first inference result, and the ground truth label of the first domain data.

More specifically, the second update unit 142 calculates a loss Lreal from a difference between the first inference result and the ground truth label of the first domain data. Similarly, the second update unit 142 calculates a loss Lfake from a difference between the second inference result and the ground truth label of the first translated data. Then the second update unit 142 uses following Expression (1) to determine a loss L by adding a weighted Lreal and a weighted L_{fake},

L=a*Lᵣₑₐₗb*L_{fake} (1)

where a and b are predetermined constants.

Then the second update unit 142 updates the parameters of the first neural networks 101a and 101b so that the loss L becomes minimum.

Note that a method for updating parameters of the first neural networks 101a and 101b is not limited to the method described herein, but may be any method for making output of the first neural networks 101a and 101b closer to the ground truth labels of the first and second domain data.

Alternatively, the loss may be calculated by any loss calculation method as long as the loss is allowed to retroact to the neural networks and update parameters. A loss calculation method that corresponds to a task may be selected. For example, class classification, such as SoftmaxCrossEntropyLoss, or regression, such as L1Loss or L2Loss, may be selected as a loss calculation method. Further, the above constants a and b are appropriately varied according to a degree of progress of the learning.

Further, the second update unit 142 updates the parameters of the second neural network 102 on the basis of the second inference result, the ground truth label of the first translated data, the first inference result, and the ground truth label of the first domain data. More specifically, the second update unit 142 updates the parameters of the second neural network 102 so that the loss L becomes minimum.

### Example of Learning Method

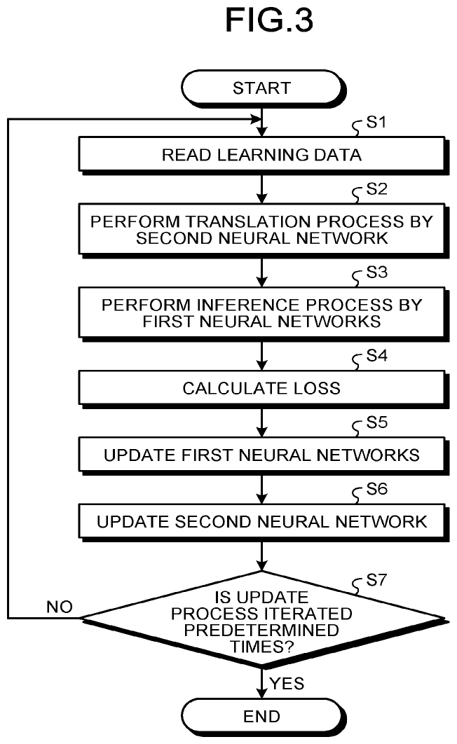

FIG. 3 is a flowchart that illustrates an example of a learning method according to the first embodiment. First, the obtaining unit 11 reads, from the storage circuit 20, learning data (first domain data, a ground truth label of the first domain data, second domain data, and a ground truth label of the second domain data) (Step S1).

For example, when the first domain data is actual images and the second domain data is CGs, the obtaining unit 11 may read the actual images and ground truth labels therefor one by one, and may read the CGs and ground truth labels therefor one by one. Alternatively, the obtaining unit 11 may read, for example, a set of the actual images and ground truth labels therefor, and a set of the CGs and ground truth labels therefor. Herein, the set means the actual images and the ground truth labels therefor or the CGs and the ground truth labels therefor of two by two, four by four, eight by eight, or the like, for example. Alternatively, for example, the number of pieces of the first domain data read by the obtaining unit 11 may be different from the number of pieces of the second domain data read by the obtaining unit 11.

Hereinafter, such set of input (a unit of data that is processed at a time) may be referred to as a batch. Further, the number of parameter update processes for one input batch may be referred to as an iteration number.

Next, the translation unit 12 uses the second neural network 102 to perform a translation process (Step S2). More specifically, the translation unit 12 inputs the second domain data in the read batch into the second neural network 102 to generate first translated data.

Next, the inference unit 13 uses the first neural networks 101a and 101b to perform an inference process (Step S3). The first domain data in the read batch is input into the first neural network 101a. The first translated data that has been obtained in the process in Step S2 is input into the first neural network 101b.

Next, a loss defined by above Expression (1) is calculated by the second update unit 142 on the basis of results of the processes in Step S2 and Step S3 (Step S4).

Next, the second update unit 142 updates the first neural networks 101a and 101b on the basis of the loss calculated by the process in Step S4 (Step S5).

Next, the first update unit 141 and the second update unit 142 update the second neural network 102 (Step S6). More specifically, the first update unit 141 updates parameters of the second neural network 102 so that a distribution that represents features of the first translated data becomes similar to a distribution that represents features of the first domain data. Further, the second update unit 142 updates the second neural network 102 on the basis of the loss calculated by the process in Step S4.

Next, the update unit 14 determines whether or not the update process is iterated predetermined times (iteration number) (Step S7). If the update process is not iterated the predetermined times (Step S7, No), the process returns to Step S1. If the update process is iterated the predetermined times (Step S7, Yes), the process ends.

As described above, in the learning device 1 according to the first embodiment, the inference unit 13 uses the first neural network 101 to perform an inference task. The first neural network 101 receives first domain data and outputs a first inference result. The translation unit 12 uses the second neural network 102 to translate second domain data into first translated data. The second neural network 102 receives the second domain data, and translates the second domain data into the first translated data similar to the first domain data. The first update unit 141 updates parameters of the second neural network 102 so that a distribution that represents features of the first translated data becomes similar to a distribution that represents features of the first domain data. The second update unit 142 updates parameters of the first neural network 101 on the basis of a second inference result, a ground truth label of the first translated data, a first inference result, and a ground truth label of the first domain data. The second inference result is output from the first neural network 101 into which the first translated data is input.

Consequently, the learning device 1 according to the first embodiment generates learning data that is appropriate for improvement in generalization performance of the neural network used for estimation (first neural network 101). More specifically, the learning device 1 according to the first embodiment can simultaneously learn the first neural network 101 and the second neural network 102. For example, the first neural network 101 receives actual images and performs target inference tasks. For example, the second neural network 102 translates CGs or the like into domain data similar to the actual images. The CGs or the like allow generation of a plurality of labeled images. Consequently, images appropriate for improvement in generalization performance of an estimation network (first neural network 101) that estimates first domain images (actual images or the like) are generated from second domain images (CGs or the like). The generalization performance of the estimation network is improved.

### Second Embodiment

Next, a second embodiment will be described. In the description of the second embodiment, description similar to the description in the first embodiment will be omitted, and points different from the first embodiment will be described.

### Configuration Example of Neural Networks

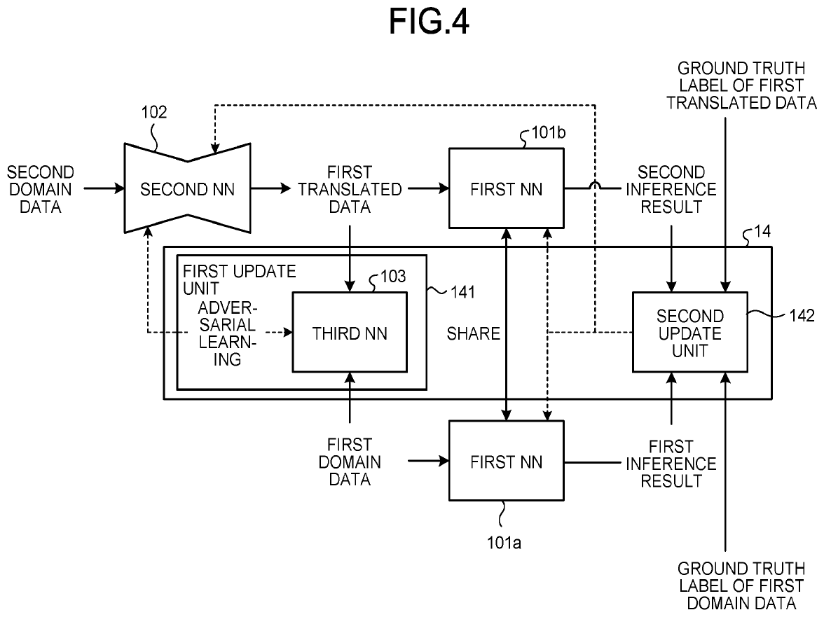

FIG. 4 is a diagram that illustrates a configuration example of neural networks according to the second embodiment. As illustrated in FIG. 4, a difference between the second embodiment and the first embodiment is that a first update unit 141 further uses a third neural network 103 to perform an update process.

The third neural network 103 receives input of first domain data or first translated data. The third neural network 103 determines whether or not the input is the first domain data (identifies whether the input is the first domain data or the first translated data).

The first update unit 141 uses the third neural network 103 to adversarially learn a second neural network 102 and the third neural network 103. Consequently, the first update unit 141 updates parameters of the second neural network 102 and the third neural network 103.

If the first domain data is input, the first update unit 141 updates the parameters of the third neural network 103 so that one is output. Alternatively, if the first translated data is input, the first update unit 141 updates the parameters of the third neural network 103 so that zero is output. Following Expression (2), for example, represents a loss L_{dis} that should be minimized by updating the parameters of the third neural network 103.

L_{dis}=E(log(D(x)))+E(log(1−D(y))) (2)

E( ) represents an expected value. x represents a set of input sampled from the first domain data. y represents a set of input sampled from the first translated data output from the second neural network 102 into which a set of input sampled from second domain data is input. D(x) represents output from the third neural network 103 into which x is input. D(y) represents output from the third neural network 103 into which y is input.

Further, the first update unit 141 updates the parameters of the second neural network 102 so that one is output from the third neural network 103 into which the first translated data is input. That is to say, the first update unit 141 updates the parameters so that the following loss L_{gen} is minimized.

L_{gen}=E(log(D(y))) (3)

Note that details of an adversarial learning method are described in, for example, SPLAT: Semantic Pixel-Level Adaptation Transforms for Detection (https://arxiv.org/pdf/1812.00929.pdf). Further, instead of above Expressions (2) and (3), a squared error may be minimized as in Expressions (4) and (5).

L_{dis}=E((1−D(x))²)+E((D(y))²) (4)

L_{gen}=E((1−D(y))²) (5)

Note that expressions that define the losses are not limited to Expressions (2) to (5) that are presented herein. The losses may be defined by any expression as long as the losses can be adversarially learned.

Alternatively, when the second neural network 102 is trained, the update unit 14 (first update unit 141 and second update unit 142) may use following Expression (6) for the above Lgen and updates the parameters to minimize the L_{gen}.

L=E((1−D(y))2)+c*L (6)

c is a predetermined constant. L is a loss of first neural networks 101a and 101b. The loss of the first neural networks 101a and 101b is defined by above Expression (1). Since the update unit 14 (first update unit 141 and second update unit 142) updates the parameters to minimize the L_{gen}, the second neural network 102 is trained while the loss of the first neural networks 101a and 101b is considered. Consequently, the second neural network 102 is trained so that the second neural network 102 can generate first translated data that improves generalization performance of the first neural networks 101a and 101b.

### Example of Learning Method

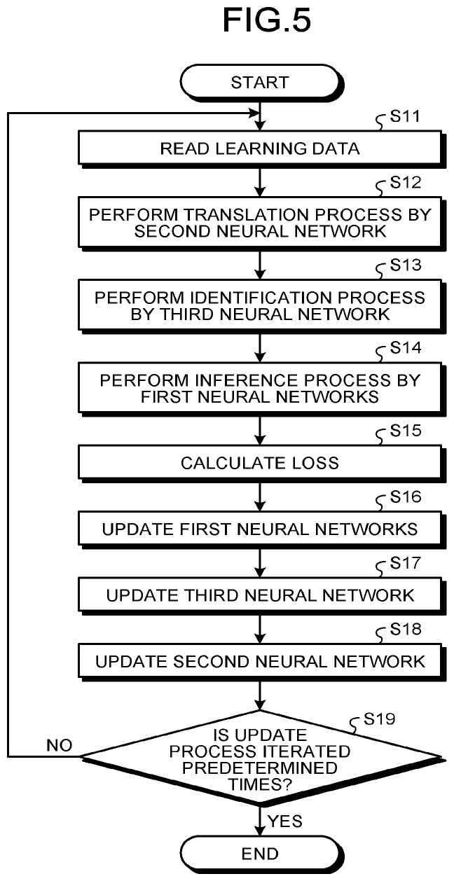

FIG. 5 is a flowchart that illustrates an example of a learning method according to the second embodiment. The descriptions for the processes in Step S11 and Step S12 are omitted since the processes in Step S11 and Step S12 are the same as the processes in Step S1 and Step S2 according to the first embodiment (see FIG. 3).

Next, the first update unit 141 uses the third neural network 103 to perform an identification process of first domain data and first translated data obtained by a translation process in Step S12 (Step S13). More specifically, the first update unit 141 inputs first translated data, and first domain data in a read batch into the third neural network 103, and obtains an output result.

Next, an inference unit 13 uses the first neural networks 101a and 101b to perform an inference process (Step S14). The first domain data in the read batch is input into the first neural network 101a. The first translated data that has been obtained in the process in Step S12 is input into the first neural network 101b.

Next, losses defined by above Expressions (1), (2), and (6) are calculated by the first update unit 141 and the second update unit 142 on the basis of results of the processes in Step S12 to Step S14 (Step S15).

Next, the second update unit 142 updates the first neural networks 101a and 101b on the basis of the loss calculated by above Expression (1) in the process in Step S15 (Step S16).

Next, the first update unit 141 updates the third neural network 103 on the basis of the loss calculated by above Expression (2) in the process in Step S15 (Step S17).

Next, the update unit 14 (first update unit 141 and second update unit 142) updates the second neural network 102 on the basis of the loss calculated by above Expression (6) in the process in Step S15 (Step S18).

Next, the update unit 14 determines whether or not the update process is iterated predetermined times (iteration number) (Step S19). If the update process is not iterated the predetermined times (Step S19, No), the process returns to Step S1. If the update process is iterated the predetermined times (Step S19, Yes), the process ends.

### Variation of Second Embodiment

Next, a variation of the second embodiment will be described. In the description of the variation, description similar to the description in the second embodiment will be omitted, and points different from the second embodiment will be described. At least two or more neural networks of first neural networks 101a and 101b, a second neural network 102, and a third neural network 103 share at least part of weights.

### Configuration Example of Neural Networks

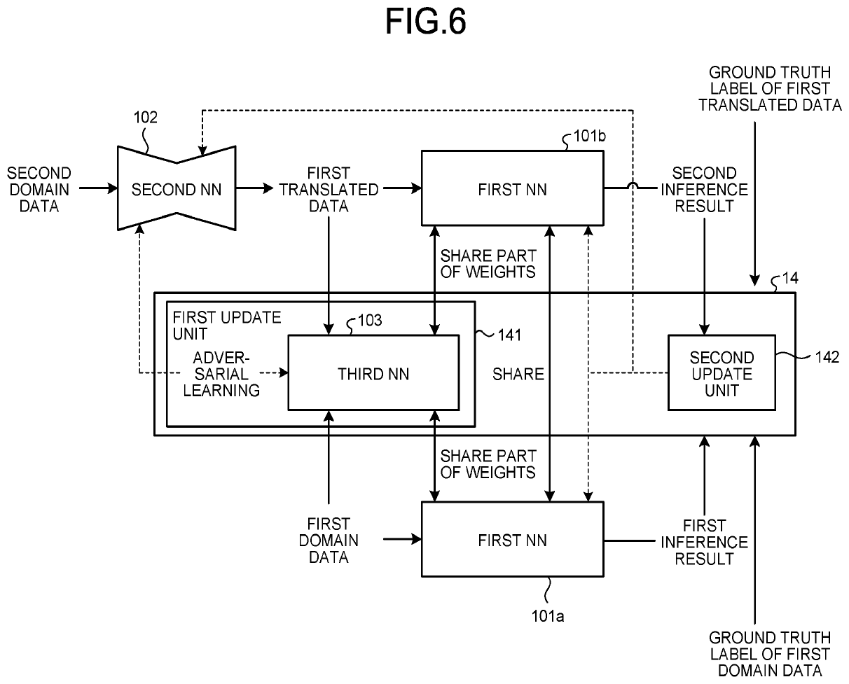

FIG. 6 is a diagram that illustrates a configuration example of neural networks according to the variation of the second embodiment. In the example in FIG. 6, the third neural network 103 and the first neural networks 101a and 101b share part of weights. In the example in FIG. 6, the shared weights are updated by both a first update unit 141 and a second update unit 142.

### Third Embodiment

Next, a third embodiment will be described. In the description of the third embodiment, description similar to the description in the variation of the second embodiment will be omitted, and points different from the variation of the second embodiment will be described. A CycleGAN configuration is applied to the third embodiment.

### Configuration Example of Neural Networks

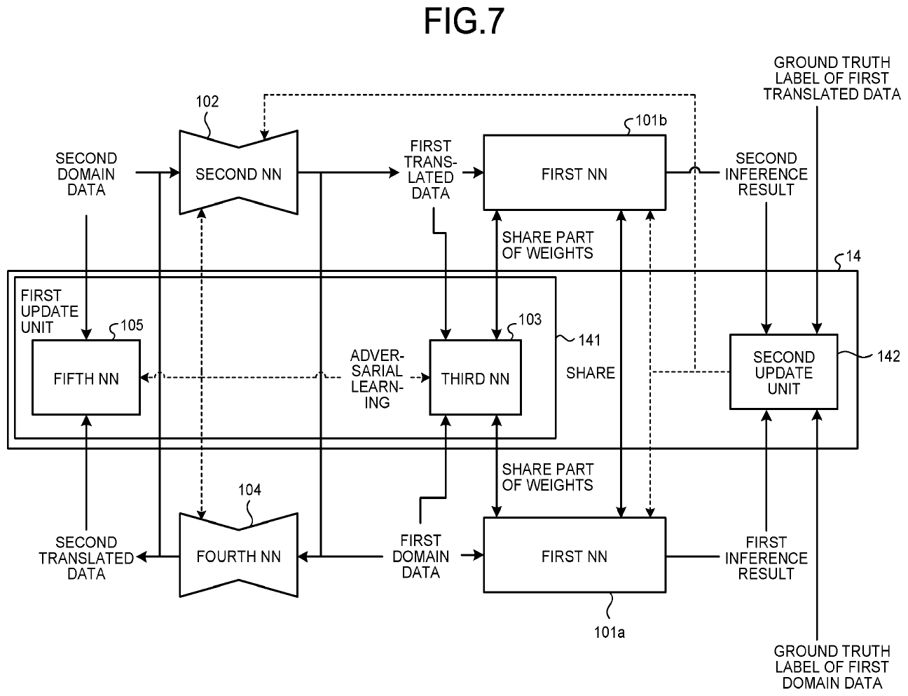

FIG. 7 is a diagram that illustrates a configuration example of neural networks according to the third embodiment. In the third embodiment, a fourth neural network 104 and a fifth neural network 105 are added, as illustrated in FIG. 7.

If the fourth neural network 104 receives input of first domain data, the fourth neural network 104 translates the first domain data into second translated data similar to second domain data, and outputs the second translated data.

The fifth neural network 105 receives input of the second domain data or the second translated data. The fifth neural network 105 determines whether or not the input is the second domain data (identifies whether the input is the second domain data or the second translated data).

In the configuration in FIG. 7, if the second domain data is input into the fifth neural network 105, a first update unit 141 updates parameters of the fifth neural network 105 so that one is output. Alternatively, if the second translated data is input into the fifth neural network 105, the first update unit 141 updates parameters of the fifth neural network 105 so that zero is output.

Further, the first update unit 141 updates parameters of a second neural network 102 and the fourth neural network 104 so that one is output from the fifth neural network 105 into which the second translated data is input.

That is to say, the first update unit 141 updates the parameters so that the following loss is minimized.

L_{dis}=E(log(DB(x)))+E(log(1−DB(y))) (2′)

DB(x) represents output from the fifth neural network 105. x represents a set of input sampled from the second domain data. y represents a set of input sampled from the second translated data output from the fourth neural network 104 into which a set of input sampled from the first domain data is input. Alternatively, instead of above Expression (2′), a squared error may be minimized as in Expression (4′).

L_{dis}=E((1−DB(x))+E((DB(y))²) (4′)

Further, the first update unit 141 further updates the parameters of the second neural network 102 and the fourth neural network 104 so that output from the second neural network 102 into which the second translated data is input becomes the same as the first domain data. That is to say, the first update unit 141 updates the parameters so that the following loss is minimized.

L_{gen}=(E((1−DA(y))²)+E((1−DB(GB(x)))²))/2+λE(||GA(GB(x))−x||₁) (7)

DA(x) represents output from a third neural network 103 into which x is input. DB(x) represents output from the fifth neural network 105 into which x is input. Further, GB(x) represents output from the fourth neural network 104 into which x is input. GA(x) represents output from the second neural network 102 into which x is input. Further, A is a predetermined coefficient.

Note that details of such an adversarial learning method of translating a style of the first domain data and a style of the second domain data into each other are described in, for example, Jun-Yan Zhu, Taesung Park, Phillip Isola, Alexei A. Efros, “Unpaired Image-to-Image Translation using Cycle-Consistent Adversarial Networks” ICCV 2017.

Further, in the configuration in FIG. 7, the first domain data includes, for example, captured images. The second domain data includes, for example, CGs. The first translated data includes, for example, CGs similar to the captured images. The second translated data includes, for example, CGs translated from the captured images.

In the third embodiment, due to the above configuration in FIG. 7, a translation unit 12 uses the fourth neural network 104 to further translate first domain data into second translated data. The fourth neural network 104 receives the first domain data, and translates the first domain data into the second translated data similar to second domain data. Then the first update unit 141 uses the fifth neural network 105 to adversarially learn the fourth neural network 104 and the fifth neural network 105. Consequently, the first update unit 141 further updates parameters of the fourth neural network 104 and the fifth neural network 105. The fifth neural network 105 receives input of the second translated data or the second domain data, and determines whether or not the input is the second domain data. Further, the first update unit 141 further updates parameters of the second neural network 102 and the parameters of the fourth neural network 104, on the basis of the first domain data, and output from the second neural network 102 into which the second translated data is further input.

### Example of Learning Method

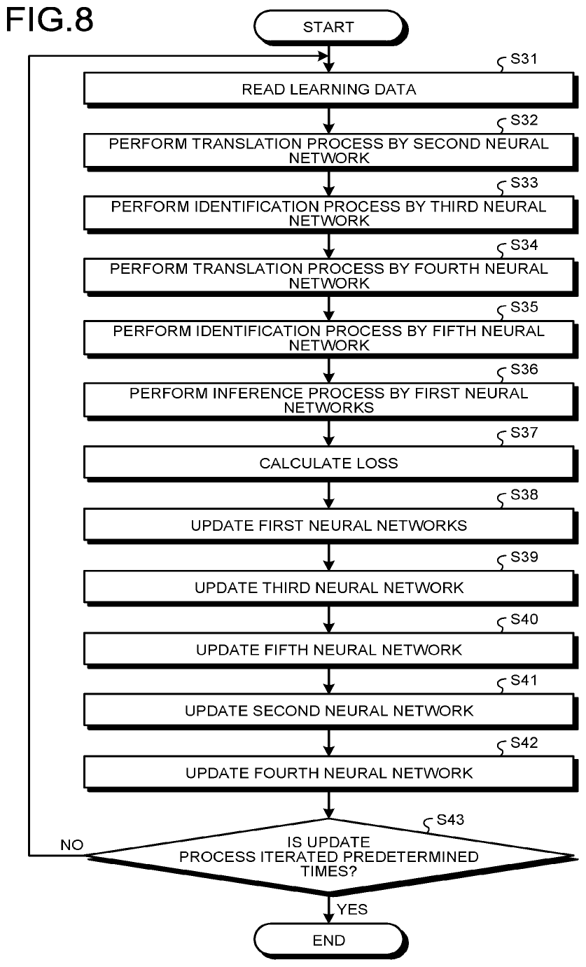

FIG. 8 is a flowchart that illustrates an example of a learning method according to the third embodiment. The descriptions for the processes in Step S31 to Step S33 are omitted since the processes in Step S31 to Step S33 are the same as the processes in Step S11 to Step S13 according to the second embodiment (see FIG. 5).

Next, the translation unit 12 uses the fourth neural network 104 to perform a translation process (Step S34). More specifically, the translation unit 12 inputs first domain data in a read batch into the fourth neural network 104 to generate second translated data.

Next, the first update unit 141 uses the fifth neural network 105 to perform an identification process of second domain data and first translated data obtained by the translation process in Step S34 (Step S35). More specifically, the first update unit 141 inputs the second translated data, and the first domain data in the read batch into the fifth neural network 105, and obtains an output result.

Next, an inference unit 13 uses first neural networks 101a and 101b to perform an inference process (Step S36). The first domain data in the read batch is input into the first neural network 101a. The first translated data that has been obtained in the process in Step S32 is input into the first neural network 101b.

Next, losses defined by above Expressions (1), (2), (2′), and (7) are calculated by the first update unit 141 and a second update unit 142 on the basis of results of the processes in Step S32 to Step S36 (Step S37).

Next, the second update unit 142 updates the first neural networks 101a and 101b on the basis of the loss calculated by above Expression (1) in the process in Step S37 (Step S38).

Next, the first update unit 141 updates the third neural network 103 on the basis of the loss calculated by above Expression (2) in the process in Step S37 (Step S39).

Next, the first update unit 141 updates the fifth neural network 105 on the basis of the loss calculated by above Expression (2′) in the process in Step S37 (Step S40).

Next, the first update unit 141 updates the second neural network 102 on the basis of the loss calculated by above Expression (7) in the process in Step S37 (Step S41).

Next, the first update unit 141 updates the fourth neural network 104 on the basis of the loss calculated by above Expression (7) in the process in Step S37 (Step S42).

Next, the update unit 14 determines whether or not the update process is iterated predetermined times (iteration number) (Step S43). If the update process is not iterated the predetermined times (Step S43, No), the process returns to Step S1. If the update process is iterated the predetermined times (Step S43, Yes), the process ends.

### Fourth Embodiment

Next, a fourth embodiment will be described. In the description of the fourth embodiment, description similar to the description in the third embodiment will be omitted, and points different from the third embodiment will be described.

### Configuration Example of Neural Networks

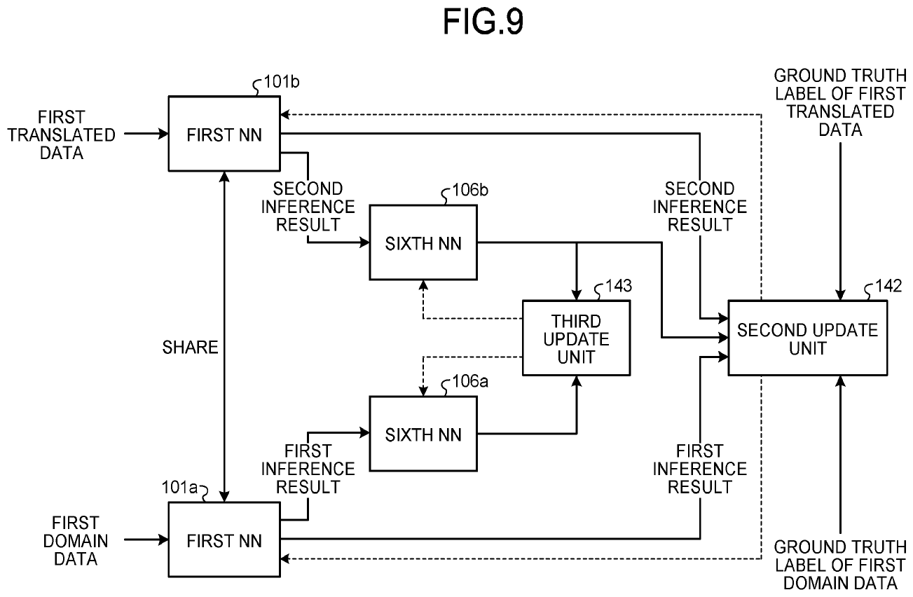

FIG. 9 is a diagram that illustrates a configuration example of neural networks according to the fourth embodiment. Note that in FIG. 9, sixth neural networks 106a and 106b are added between first neural networks 101a and 101b and a second update unit 142. Configurations of other portions of the fourth embodiment are the same as the configuration of the third embodiment (see FIG. 7).

As illustrated in FIG. 9, the sixth neural networks 106a and 106b are neural networks that identify (determine) whether input is a first inference result or a second inference result. As output of the sixth neural networks 106a and 106b becomes closer to, for example, one, the input is more likely to be the first inference result. The sixth neural networks 106a and 106b share at least part of or all of weights of the neural networks. If all parameters (weights) are shared between the sixth neural networks 106a and 106b, the sixth neural networks 106a and 106b are implemented as one sixth neural network 106.

A third update unit 143 updates parameters of the sixth neural networks 106a and 106b. The third update unit 143 receives output from the sixth neural networks 106a and 106b. The third update unit 143 updates the parameters of the sixth neural networks 106a and 106b so that the sixth neural network 106a outputs one and the sixth neural network 106b outputs zero. Following Expression (8) or (8′), for example, represents a loss L_{dis} that should be minimized by updating the parameters of the sixth neural networks 106a and 106b.

L_{dis}=E(log(DW(x)))+E(log(1−DW(y))) (8)

L_{dis}=E((1−DW(x))²)+E((DW(y))²) (8′)

E( ) represents an expected value. x represents a set of first inference results output from the first neural network 101a into which a set of input sampled from first domain data is input. y represents a set of second inference results output from the first neural network 101b into which output from a second neural network is input. The second neural network translates a set of input sampled from second domain data, and outputs the set of translated input. DW(x) represents output from the sixth neural networks 106a and 106b into which x is input. DW(y) represents output from the sixth neural networks 106a and 106b into which y is input.

Further, in the fourth embodiment, the second update unit 142 updates the first neural networks 101a and 101b on the basis of the first inference result, a ground truth label of the first domain data, the second inference result, and a ground truth label of first translated data, and output from the sixth neural network 106b. More specifically, as output from the sixth neural network 106b becomes closer to one, it is determined that the first inference result and the second inference result become closer. The first domain data (for example, actual images) is used for the first inference result. The first translated data (for example, data that includes images like actual images translated from CGs) is used for the second inference result. Therefore, if output from the sixth neural network 106b is not less than a predetermined threshold (for example, 0.5), the second update unit 142 updates parameters of the first neural networks 101a and 101b by using a loss calculated by the second update unit 142 (allows the loss to affect the first neural networks 101a and 101b).

Further, for example, the sixth neural networks 106a and 106b depthwise or pointwise divide output from the first neural networks 101a and 101b into at least one output. Alternatively, for example, the sixth neural networks 106a and 106b divide, on the basis of a set of output nodes, output from the first neural networks 101a and 101b into at least one output. Further, for example, the sixth neural networks 106a and 106b perform processes for each of the divided output.

In this case, a mean value of at least one output that corresponds to divided output may be determined. Parameters may be updated by allowing a loss calculated by the second update unit 142 to affect parts of output from the first neural networks 101a and 101b that are not less than the mean value. Alternatively, if parts of output from the sixth neural network 106b into which the divided output from the first neural networks 101a and 101b is input are not less than a predetermined threshold, parameters may be updated by allowing a loss calculated by the second update unit 142 to affect the parts of output from the sixth neural network 106b that are not less than the predetermined threshold.

### Example of Learning Method

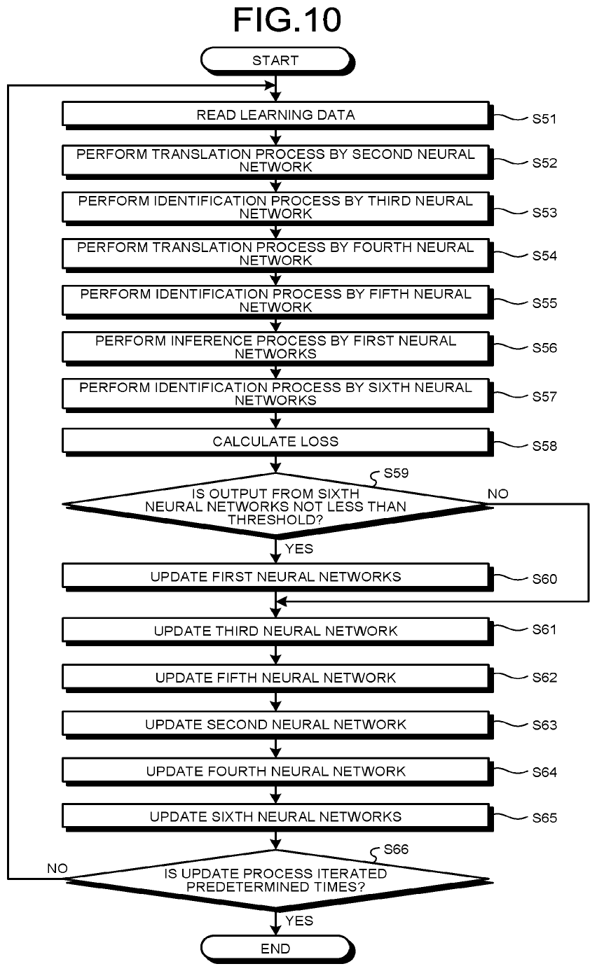

FIG. 10 is a flowchart that illustrates an example of a learning method according to the fourth embodiment. The descriptions for the processes in Step S51 to Step S56 are omitted since the processes in Step S51 to Step S56 are the same as the processes in Step S31 to Step S36 according to the third embodiment (see FIG. 8).

Next, the third update unit 143 uses the sixth neural networks 106a and 106b to perform an identification process of first and second inference results (Step S57).

Next, losses defined by above Expressions (1), (2), and (6) or (7), and (8) are calculated by a first update unit 141, the second update unit 142, and the third update unit 143 on the basis of results of the processes in Step S52 to Step S56 (Step S58).

Next, the second update unit 142 determines whether or not output from the sixth neural network 106b is not less than a threshold (for example, 0.5) (Step S59). If the output is not less than the threshold (Step S59, Yes), the process proceeds to Step S60. If the output is less than the threshold (Step S59, No), the process proceeds to Step S61.

The descriptions for the processes in Step S60 to Step S64 are omitted since the processes in Step S60 to Step S64 are the same as the processes in Step S38 to Step S42 according to the third embodiment (see FIG. 8).

Next, the third update unit 143 updates parameters of the sixth neural networks 106a and 106b (Step S65). More specifically, the third update unit 143 updates the sixth neural networks 106a and 106b on the basis of the loss calculated by above Expression (8) in the process in Step S58. That is to say, the third update unit 143 updates parameters of the sixth neural networks 106a and 106b so that the sixth neural network 106a outputs one and the sixth neural network 106b outputs zero.

Next, an update unit 14 determines whether or not the update process is iterated predetermined times (iteration number) (Step S66). If the update process is not iterated the predetermined times (Step S66, No), the process returns to Step Sl. If the update process is iterated the predetermined times (Step S66, Yes), the process ends.

Note that the above processing functions of the learning device 1 according to the first to fourth embodiments are implemented by, for example, the learning device 1 that includes a computer and executes programs, as described above. In this case, programs executed by the learning device 1 according to the first to fourth embodiments may be stored in a computer connected through a network, such as the Internet, and may be provided by downloading the programs through the network. Alternatively, programs executed by the learning device 1 according to the first to fourth embodiments may be provided or distributed through a network, such as the Internet. Alternatively, programs executed by the learning device 1 according to the first to fourth embodiments may be preliminarily built into a non-volatile storage medium, such as read-only memory (ROM), and be provided.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A learning device comprising:
a hardware processor configured to:
perform an inference task by using a first neural network, the first neural network being configured to receive first domain data and output a first inference result;
translate second domain data into first translated data similar to the first domain data by using a second neural network, the second neural network being configured to receive the second domain data and translate the second domain data into the first translated data;
update parameters of the second neural network so that a distribution that represents a feature of the first translated data approaches a distribution that represents a feature of the first domain data; and
update parameters of the first neural network on a basis of a second inference result output when the first translated data is input into the first neural network, a ground truth label of the first translated data, the first inference result, and a ground truth label of the first domain data.

2. The device according to claim 1, wherein
the hardware processor is further configured to perform, using a third neural network, adversarial learning on the second and third neural networks to update the parameters of the second and third neural networks, the third neural network being configured to receive input of the first domain data or the first translated data and to determine whether or not the input is the first domain data.

3. The device according to claim 2, wherein
at least two or more neural networks of the first to third neural networks share at least part of weights.

4. The device according to claim 1, wherein
the hardware processor is further configured to update the parameters of the second neural network on a basis of the second inference result, the ground truth label of the first translated data, the first inference result, and the ground truth label of the first domain data.

5. The device according to claim 1, wherein
the hardware processor is further configured to:
translate, using a fourth neural network, the first domain data into second translated data similar to the second domain data, the fourth neural network being configured to receive the first domain data and translate the first domain data into the second translated data; and
perform, using a fifth neural network, adversarial learning on the fourth and fifth neural networks to further update parameters of the fourth and fifth neural networks, and is configured to further update the parameters of the second and fourth neural networks on a basis of the first domain data and output when the second translated data is further input into the second neural network, the fifth neural network being configured to receive input of the second translated data or the second domain data and determine whether or not the input is the second domain data.

6. The device according to claim 5, wherein
the first domain data includes a captured image,
the second domain data includes a computer graphic (CG),
the first translated data includes a CG similar to the captured image, and
the second translated data includes a CG translated from the captured image.

7. The device according to of claim 1, wherein
the hardware processor is further configured to:
update parameters of a sixth neural network, the sixth neural network being configured to receive input of the first or second inference result and determine whether or not the input is the first inference result; and
determine whether or not the parameters of the first neural network will be updated, on a basis of output from the sixth neural network into which the second inference result is input.

8. A learning method comprising:
performing an inference task by using a first neural network, the first neural network being configured to receive first domain data and output a first inference result;
translating second domain data into first translated data similar to the first domain data by using a second neural network, the second neural network being configured to receive the second domain data and translate the second domain data into the first translated data;
updating parameters of the second neural network so that a distribution that represents a feature of the first translated data approaches a distribution that represents a feature of the first domain data; and
updating parameters of the first neural network on a basis of a second inference result output when the first translated data is input into the first neural network, a ground truth label of the first translated data, the first inference result, and a ground truth label of the first domain data.

9. A computer program product comprising a non-transitory computer-readable medium including programmed instructions, the instructions causing a computer to execute:
performing an inference task by using a first neural network, the first neural network being configured to receive first domain data and output a first inference result;
translating second domain data into first translated data similar to the first domain data by using a second neural network, the second neural network being configured to receive the second domain data and translate the second domain data into the first translated data;
updating parameters of the second neural network so that a distribution that represents a feature of the first translated data approaches a distribution that represents a feature of the first domain data; and
updating parameters of the first neural network on a basis of a second inference result output when the first translated data is input into the first neural network, a ground truth label of the first translated data, the first inference result, and a ground truth label of the first domain data.
